(19) United States
(12) Patent Application Publication
(10) Pub. No.: US 2007/0022976 A1
(43) Pub. Date: Feb. 1, 2007

(54) Performance of interal combustion engines

(76) Inventor: Moshe Lev Lerner, Ashdod (IL)

Correspondence Address: ROBERT W. J. USHER;PATENT AGENT, 1133 BROADWAY, #1515, NEW YORK, NY, 10010, US

(21) Appl. No.: 11/454,152

(22) Filed: Jun. 14, 2006

Related U.S. Application Data
(60) Provisional application No. 60/690,670, filed on Jun. 15, 2005.

(51) Int. Cl. F02B 43/08

(52) U.S. Cl. 123/3

(57) ABSTRACT

An internal combustion engine with fuel injection is supplied with a portion of fuel injected at ambient temperature into a cracking reactor chamber also receiving air and, is heated by waste heat from a conventional engine component operating normally, to sustain cracking of the injected fuel so that a cracked and gasified fuel mixed with the air is output as a continuous fuel-air stream at no greater than ambient temperature to the engine intake. The fuel portion is diverted from a conventional fuel supply from a single tank or fed from an additional tank of alternative fuel. The component emitting waste heat is engine coolant or the exhaust manifold, according to fuel volatility. Alternatively, a first tubular section of the reactor with injectors can be mounted on the intake of a conventional turbocharger which supplies the heat sustaining cracking and forms, in effect, a second section of the reactor chamber.

### RELATED APPLICATION

Priority is claimed from my provisional application 60/690,670 filed Jun. 15, 2005, the disclosure of which is incorporated herein by reference.

### FIELD OF THE INVENTION

The invention relates to systems and apparatus for improving the performance of internal combustion engines by supplying fuel gasified by cracking and/or compressed air to increase, for example, power output, efficiency, alternative fuel capability and to reduce environmentally harmful emissions.

### BACKGROUND OF THE INVENTION

There have been numerous attempts over many years to improve the performance of internal combustion engines of road vehicles by promoting fuel vaporization by heating only a portion and/all the fuel to an elevated temperature prior to or after carburetion and/or injection, but none teaches feeding only a portion of the fuel supply needed during engine operation as a liquid at ambient temperature to a fuel cracking injector operating at high pressure to initiate cracking of the fuel and mixing the cracking, gasifying fuel with air while applying waste heat energy from a conventional engine component operating normally at elevated temperature to sustain the cracking and feeding of the cracked fuel-air mixture at a relatively low temperature, no greater than ambient, directly to an intake manifold for combustion with a remainder of the fuel supplied to the engine during operation.

Additionally, although devices supplying compressed air—often known as enhanced induction devices—have been in widespread commercial use in both diesel and high performance gasoline engines for many years as conventional turbo-chargers and superchargers, such devices suffer from various disadvantages such as delays in operation (‘spooling time/lag’) and/or interference with fuel flow in the intake manifold and, overheating of intake air, requiring so-called ‘intercoolers’.

There have also been numerous attempts to provide internal combustion engines which can operate effectively, with alternative fuels, with little or no modification, but prior proposals also suffer from various practical disadvantages in terms of implementation or operation.

One example of a prior approach is disclosed in PCT/IL03/00549 filed by the present inventor on Jul. 1, 2003 and continued as US 2005/0279334, the disclosure of which is incorporated herein by reference. However, the references teaches preheating under pressure a portion of the fuel required for engine operation prior to injection so that the fuel portion is injected into the air intake at elevated temperatures, multiples of average ambient temperatures, for example, at between 60° and 100° centigrade, preferably between 70° and 85° centigrade

A disadvantage of the teaching of the above patent publication is that preheating the fuel under pressure prior to injection produces undesirable changes in the fuel chemistry. This is a reason for the prior system being unsuitable for diesel fuel. Furthermore, the patent teaching is directed to attain a lean air/fuel mixture during cruising (higher lambda) thereby to improve fuel efficiency, which approach cannot work with diesel. The different vaporization cannot support alternative fuel. In addition, as the fuel-air mixture fed to the intake is at a significantly elevated temperature, the oxygen density is decreased relative to an unheated fuel-air mixture reducing potential combustion efficiency.

### SUMMARY OF THE INVENTION

It is an object of the invention to overcome or ameliorate at least some of the disadvantages associated with prior fuel supplying systems and/or prior air boosters to enhance engine performance and to facilitate the use of alternative, cost effective fuels. It is another object of the invention to improve the performance of an internal combustion engine by supplying a portion of unheated engine fuel in a gasified fuel-air mixture at a relatively cool (ambient) temperature to an intake manifold of an internal combustion engine, by initiating cracking by high pressure injection of the portion of engine fuel to provide a sudden pressure drop and applying energy derived from waste heat from normal operation of an engine component to the cracking fuel after injection sufficient to sustain continued cracking and gasification thereafter without elevation of temperature significantly above ambient temperature.

As the liquid fuel supplied under high pressure to the injector is not heated, no undesirable changes in fuel chemistry occur. As the fuel-air mixture fed to the intake is at ambient temperature or less, the oxygen density, already enhanced by fuel cracking, is relatively high, improving combustion efficiency not only of the cracked portion but also enhancing the combustion efficiency of the conventional/main uncracked fuel supply.

A portion of liquid fuel is injected at ambient temperature and high pressure (e.g. 3-4 atmospheres/bar) into an inlet of a cracking reactor and gasifiying chamber which also has an air intake, so the fuel stream formed by injected fuel and air mixture receives energy from waste heat emitted either by the engine coolant; engine exhaust or by the engine turbocharger depending on the vaporization pressure of the fuel, and has an outlet connected to the intake manifold supplying a cracked and gasified fuel-air stream at an ambient or lower temperature. In the case of the turbocharger a numerical drop in fuel-air mixture manifold temperature reading of 70% to 80% compared with conventional turbocharger use may be obtained.

In the case of a conventional engine without a turbocharger, the drop in manifold temperature is approximately 30-40%.

In a turbocharged diesel engine which also utilizes a supply of alternative fuel, the reactor and gasifying chamber may, in effect, be largely formed by the interior of the engine turbocharger itself and an alternative fuel is injected at high pressure into the air intake of the turbocharger. The turbocharger attains a very high temperature during operation providing a heat energy source sustaining cracking of the fuel stream passing therethrough.

Heat is also transferred to any fuel droplets which may be incompletely cracked by the pressure drop on injection, by impact with the hot chamber walls and/or heated air which produces additional thermal cracking

The portion of engine fuel may be diverted from a main fuel tank or supplied by a tank of alternative fuel additional to the main fuel tank.

The invention includes a system for improving the performance of an internal combustion engine comprising:

a fuel cracking reactor comprising a chamber having an inlet and an outlet;

means for connecting an air source to the inlet;

a fuel cracking injector for the cracking reactor arranged to injecting fuel at high pressure into the inlet;

means for connecting the outlet to an intake manifold of the internal combustion engine;

means for supplying the chamber with waste heat emitted by a selected engine component during normal operation;

means for feeding a portion of engine fuel at ambient temperature to the cracking injector;

a computer control system connected to receive signals from:
a) engine temperature detecting means for detecting a temperature of engine coolant;
b) means for detecting a position of one of an engine gas pedal and throttle valve position;
c) means for sensing a type of fuel present in an engine fuel tank;

the computer control means being programmed to start operation of the injector and throttle valve in response to a signal received from the engine temperature detecting means corresponding to a minimum temperature of the engine to operate the reactor injector so that the injected fuel portion is mixed with air and undergoes continuous cracking and gasification in the chamber sustained by the heat energy supplied from the selected engine component and is fed to the intake manifold as a continuous gasified stream at ambient temperature.

In one embodiment, the means for feeding a portion of engine fuel to the reactor injector diverts such portion from the engine fuel supply.

In another embodiment, the fuel feeding means feeds the portion of fuel to the reactor injector from an additional supply of alternative fuel in an additional alternative engine fuel tank and fuel level sensing means are reconnected to the computer for sensing an amount of fuel present in the alternative engine fuel tank.

Preferably, one of an electric speedometer and vacuum sensor of main engine fuel injectors are connected to the computer so that when one of a signal received by the computer from the gas pedal indicates that the gas pedal is depressed and a signal received from the speedometer indicates that the vehicle powered by the engine is stationary, the computer implements a time delay of approximately 2-4 seconds before starting the injector. This delay usually ensures that the vehicle is moving at a reasonable speed to prevent excessive torque being imposed on the gearbox.

In a gasoline engine, the computer is connected to an oxygen sensor and programmed to detect the oxygen level.

In a preferred embodiment, the reactor chamber is elongate having the inlet and the outlet at respective opposite longitudinal ends so that only the most gasified fuel mixture exits the chamber through the outlet.

In a gasoline engine system, the reactor chamber may comprise an elongate tube having a first stage at the inlet and a second stage at the outlet, the first stage having ducts connected to receive coolant heated by the engine and the second stage being heated by engine exhaust heat. The second stage may comprise a cylindrical fuel filtering screen open at a fuel inlet end and closed at an opposite axial end having an open permitting only droplets of fuel below a predetermined small size to pass therethrough,

The number and size of injectors and reactor chambers may be increased with an increase in engine size.

Car battery operated, cold start electric heating elements may be incorporated in or associated with the low temperature preheating apparatus and/or the low temperature device of the high temperature preheating apparatus, operable to warm small quantities of fuel for several seconds prior to starting the engine.

A device for supplying compressed air or air booster, may comprises a tank of compressed air, charged by an electrically powered pump, or supplied directly by a pump, and valve means actuated by the computer in response to engine operating parameters to deliver a metered amount of air under pressure from the tank or pump directly into respective cylinder heads when the pistons are at bottom dead center (BDC). Alternatively, the air is pumped directly into the reactor chamber. Such approach both obviates spooling delay or lag normally associated with conventional turbochargers and fuel flow disruptions normally associated with superchargers mounted in the fuel path in the intake manifold. Furthermore, intercoolers are not normally required when the air booster is operated for only a few seconds at a time in a power mode, when accelerating. The air supplying device is controlled by the computer to operate only when engine operating under high load, whereas a conventional turbocharger operates continuously.

The entire system may be retrofitted to a conventional gasoline or diesel automobile engine of virtually any size.

Alternatively, the compressed air may be injected directly into the inlet of the reactor chamber instead of relying on induction by reduced manifold pressure.

It will be appreciated that the entire system of the invention is additional to a conventional engine fuel supply/combustion system and can be retro-fitted to an existing conventional engine and fuel supply system without interfering with the pre-existing operation of the conventional components. However, as the conventional engine operation and fuel supply system is controlled by a computer in response to signals received from sensors detecting various operating parameters such oxygen level, intake/induction pressure and gas pedal position, as those operating parameters will be affected by the system of the present invention and corresponding signals will be received by the conventional computer as well as the computer of the system of the invention, there will be a resulting effect on the operation of the engine determined by the conventional system. For example, as fuel supply through the reactor is increased and power demand falls, the supply of fuel by the conventional pre-existing system will decrease as a result of signal received by the conventional system computer.

Although described as a retro-fitted system, the system could be integrated by the OEM with a conventional system, for example, utilizing only a single computer.

### BRIEF DESCRIPTION OF THE DRAWINGS

In order that the invention may be readily understood, specific embodiments thereof will now be described by way of example only and with reference to the accompanying drawings in which:

FIG. 1 is a schematic perspective view from one side showing the main components of a first embodiment of the invention;

FIG. 2 is an enlarged perspective view of a low temperature fuel preheater incorporated in a fuel rail:

FIG. 3 is a diagrammatic cross-sectional view of the preheater of FIG. 2;

FIG. 4 is a similar view to FIG. 1 to a smaller scale showing the raised manifold with the second stage of the gasifier omitted;

FIG. 5 is a perspective view taken perpendicularly to FIGS. 1 and 4 (second stage of gasiifer omitted);

FIG. 6 is a diagrammatic view, partly in cross-section of the fuel gasifier;

FIG. 7 is a perspective view of the first embodiment with the second stage of the gasifier in position;

FIG. 8 is a cross-sectional view of the fuel flow control valve of FIG. 1;

FIG. 9 is a perspective view from the other side showing the main components (seond stage of gasifier omitted), particularly an air compressor or booster;

FIG. 10 is a perspective view of the invention showing the position of the air booster;

FIG. 11 is a fragmentary view of the invention showing components of the air compressor or booster adjacent an engine block;

FIG. 12 is a diagrammatic sectional view of a cylinder with connections to the air compressor or booster;

FIG. 13 is a perspective view of an alternative air porting device for the air compressor or booster;

FIG. 14 is a perspective view showing the main components of a second embodiment of the invention for diesel engine using alcohol as an additional alternative fuel in which a turbocharger provides the heat for sustaining cracking and the inlet duct forms, in effect, a downstream section of the cracking and gasifying chamber of a cracking reactor;.

FIG. 15 is a diagrammatic cross-sectional view of a methanol injection region with two injectors mounted on a tubular cracking chamber section on the intake of the turbocharger;

FIG. 16 is a diagrammatic view of a turbogasoline reactor system;

FIG. 17 is a diagrammatic view of a diesel reactor system;

FIG. 18 is a diagrammatic view of a turbodiesel reactor system;

FIG. 19a and FIG. 19b are cross-sectional views in orthogonal planes of another embodiment of cracking reactor;

FIG. 19c is a fragmentary view of a fin of the heat exchanging device of the cracking reactor;

FIG. 20 is a schematic graphical representation illustrating the relative changes in temperature of the fuel-air mixture passing through the reactor including a turbocharger and only air passing only through a conventional turbocharger (without reactor) and

FIG. 21 is a graph showing the increase in output of a turbodiesel with the present invention (MFS-molecular fuel system) compared with a conventional turbodiesel.

### DESCRIPTION OF PARTICULAR EMBODIMENTS

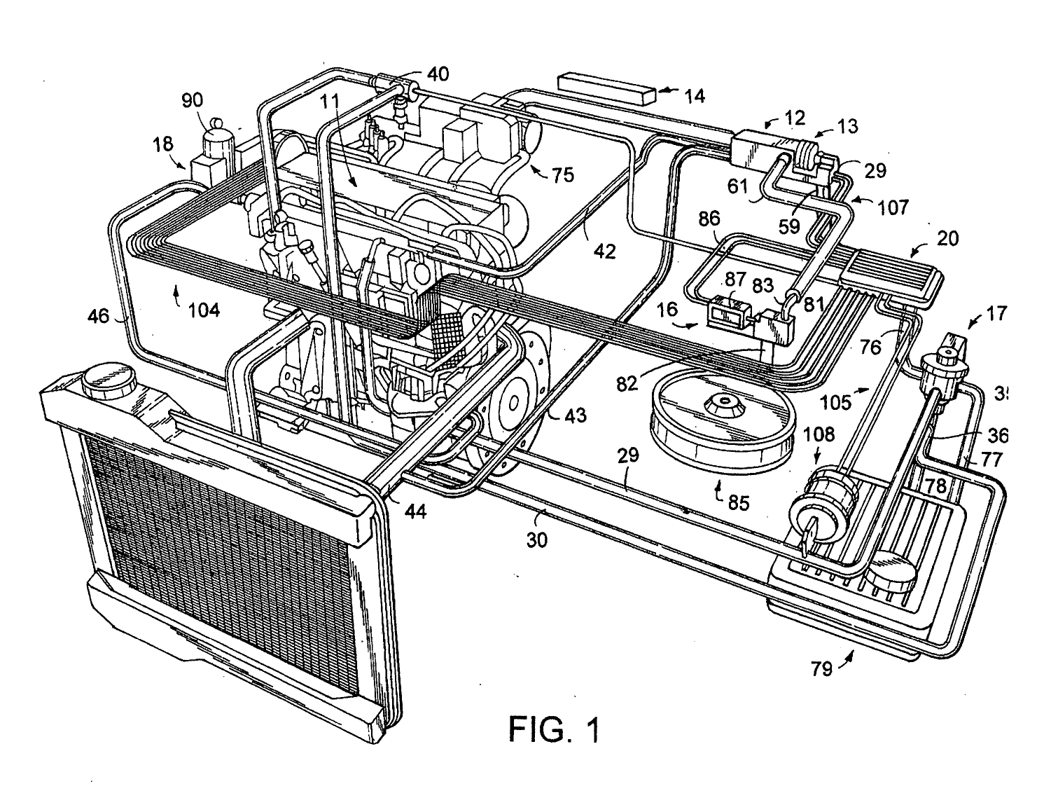

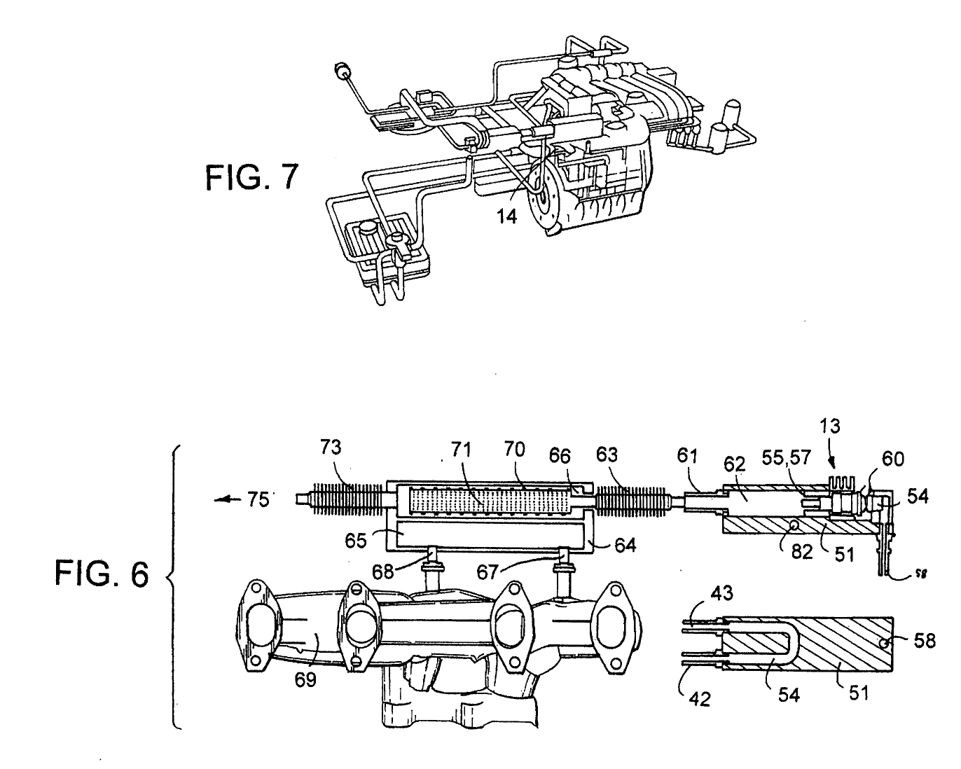

As shown in FIG. 1, main components of the system are retrofitted and include a low temperature liquid fuel preheater 11 as a fuel rail; a fuel cracking and gasifying reactor 12 comprising a first, stage device 13 with lower temperature heating outputting to a second stage device 14, (see FIG. 6), with higher temperature heating; an air regulator 16 for the fuel cracking reactor; a fuel flow control valve 17; and an air compressor or booster 18.

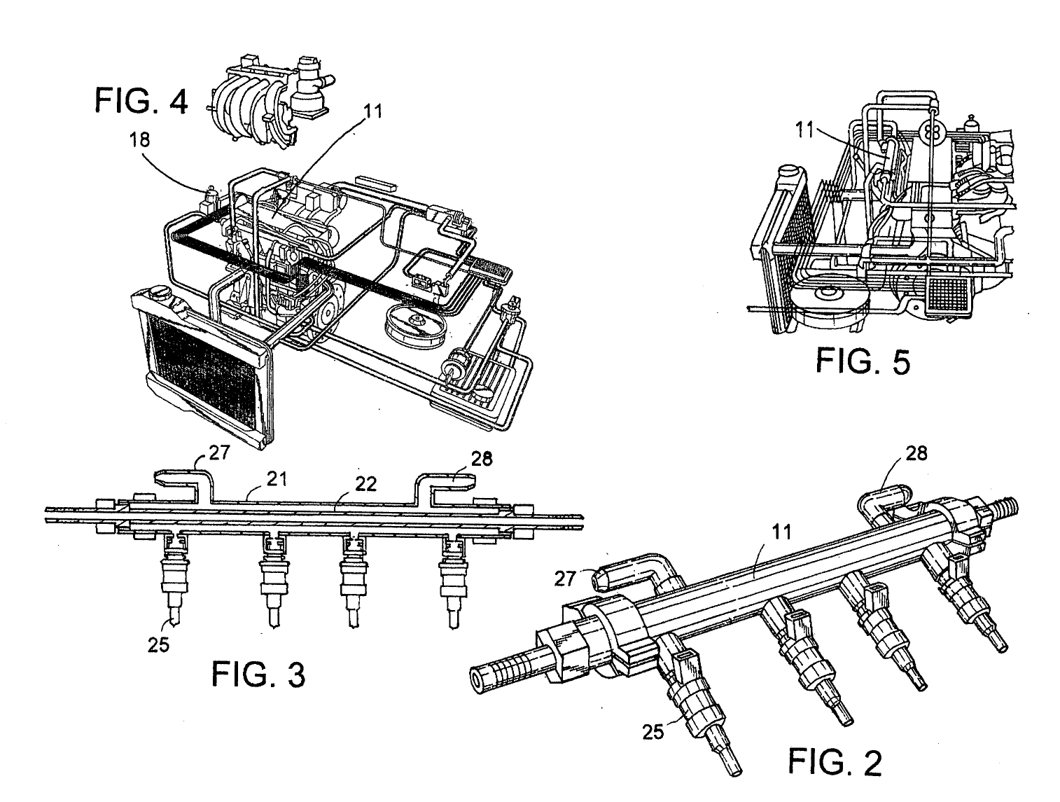

As shown more particularly in FIGS. 2 and 3, the low temperature liquid fuel preheater 11 is a heat exchanger comprising a tubular housing 21 having an inner axial passage 22 for hot radiator fluid surrounded by a jacket form chamber 23 for receiving liquid fuel to be preheated and having four fuel outlets 24 connecting directly to respective fuel injection nozzles 25 mounted in respective intake manifold passages. Fuel inlets and outlets 27 and 28 are connected by fuel supply and return lines 29, 30, respectively, to an output port 32 of the fluid flow regulator 17 which receives fuel from the fuel tank via fuel line 35 and to fuel return line 36 extending from bottom port 39 of the regulator to the tank. In one embodiment, the return line 30 is interrupted by an electrically powered cold start heater 40 having an outlet line 31 for heated fuel extending directly into the intake manifold. Adjacent the preheater, the return fuel line 30 is formed with a constriction or venturi of 0.2-0.3 mm diameter to restrict return flow of fuel, maintaining the heat exchanger full of suitably preheated fuel under pressure, enabling it to be heated safely without vaporization and inhibiting return of heated fuel to the tank. The constriction also permits any vapor formed accidentally to be vented back to the gas tank.

Hot radiator fluid is supplied to the passage 22 by fluid line 42 after circulating through the low temperature stage 13 of the cracking and gasifying reactor 12, being supplied thereto by fluid line 43 which taps radiator hose 44, returning engine heated fluid to the radiator 45. After passage through the heat exchanger, the cooler radiator fluid is returned through fluid line 46 to the engine block. The maximum fuel temperature is limited to approximately 80 degrees C.

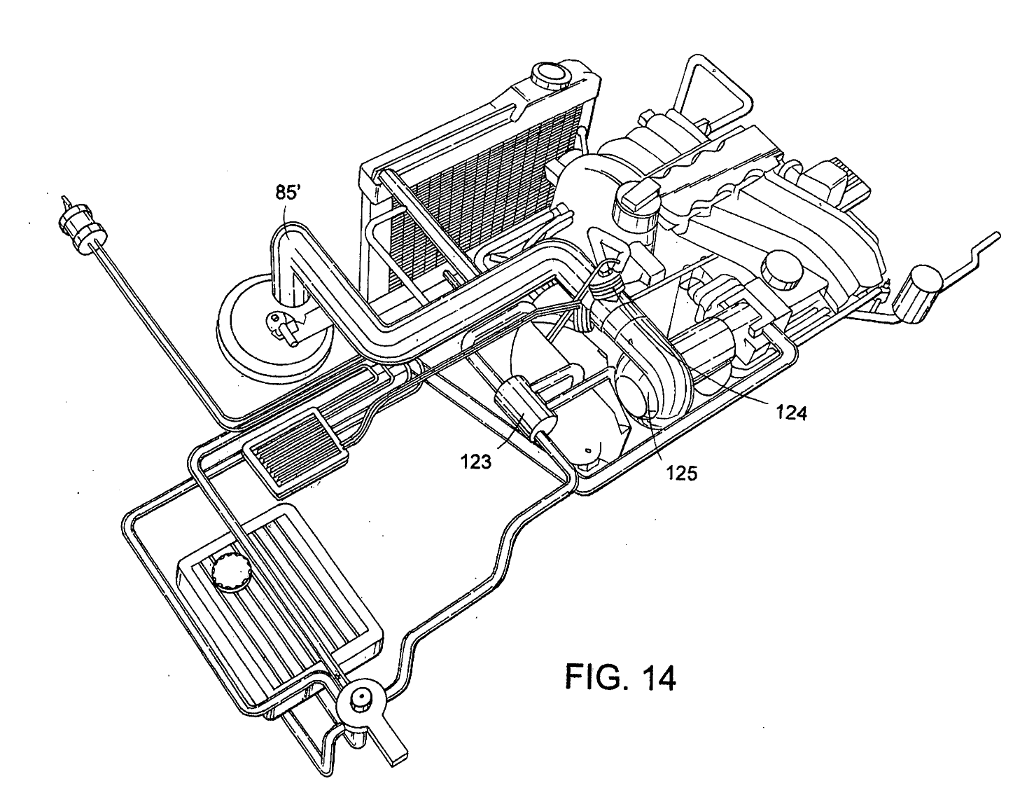

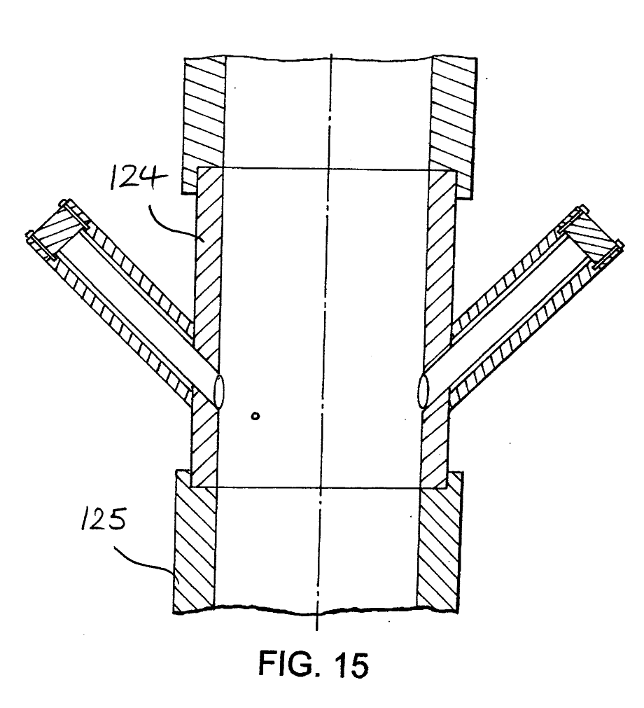

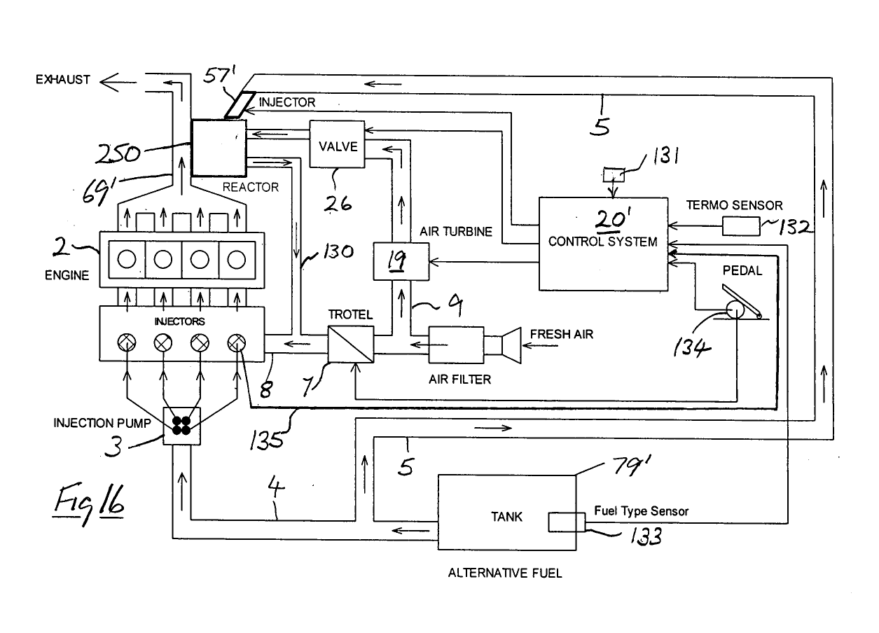

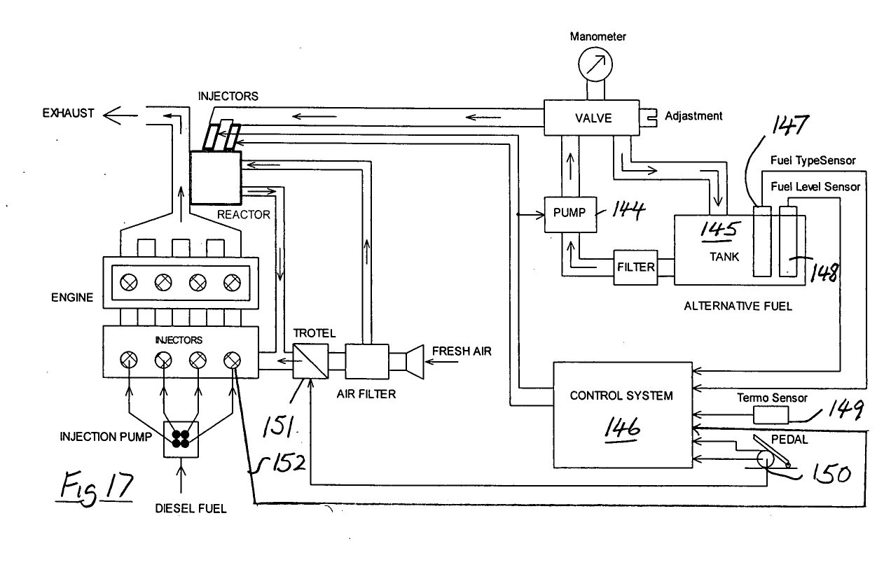

As shown in FIGS. 6 and 7, the high temperature fuel cracking/gasifying apparatus 12 comprises a first stage, lower temperature heat exchanger 13 heated by radiator fluid and a second high temperature stage 14 heated by exhaust manifold gas. (Alternatively, the cracking/ gasifying reactor is comprised by an existing engine turbocharger itself in a diesel engine version shown in FIG. 14).

The housing of the first stage comprises a lower housing block 51 having a heating fluid passageway 54 with an inlet and an outlet connected to fluid lines 43 and 42, respectively; and an upper housing part having a forward heating chamber 55 and a fuel injection nozzle 57 mounted at a rear to inject fuel into the chamber. Fuel is fed to the nozzle 57 via fitting 58 through fuel line 59 extending to a upper port on the upper body of the fuel flow control valve 17 and air is introduced through port 60 via air line 61 from the air regulator 16. An electric heating element 82 is also mounted in the upper housing for cold start activations of approximately 3 seconds duration. The heated cracking chamber is lined with mesh 62 to increase the effective surface area contacting the fuel for efficient heat exchange. In practice, the maximum fuel temperature reached is approximately 80-90 degrees C. The forward outlet of the chamber is connected to the second stage 14 by another heat exchanger formed by a finned pipe 63. The liquid fuel is injected at high pressure (2.5-3 atmospheres) into a reduced pressure area producing a pressure variation which initiates cracking expansion which is endothermic. The heat supplied to the chamber provides energy to sustain the cracking reaction.

The second, stage 14 comprises a housing 64 having a first, exhaust gas receiving chamber section 65 having inlets and outlets 67 and 68, respectively, connected to bores in the exhaust manifold 69 and, a second, fuel expansion and atomizing chamber sectiont 66 separated from the first chamber by a common heat conducting wall. The second chamber section axially receives a cylindrical screen 70, closed at a forward end and having a rear inlet receiving fuel/air mixture from the heat exchanger pipe 63. The screen has apertures 71 of 0.3-0.5 mm diameter with the number of apertures calculated to provide the same airflow as when absent. The screen aids the complete dispersion of fuel droplets, enhances heat exchange by increasing contact surface area and tends to project the fuel toward the hot wall. The screen and other interior components are made from aluminum for enhanced thermal conduction while drilled fittings to the manifold should be of stainless steel for strength. Any materials used must not glow at 400-500 deg. C., the temperature reached in the second stage. In this chamber section, most of the the fuel is gasified by the continued cracking and has acquired a negative static charge by the injection into the first stage while the engine block also acquires a negative charge, further inhibiting or preventing drop formation also assisted byn the lowered pressure. As in the first stage, the exhaust heat prevents the temperature of the gasifying fuel falling too low, as a result of the cracking and expansion, to prevent cracking continuing. The mostly gasified fuel leaves the outlet at a temperature of approximately −2 or −3 degrees centigrade via a second finned, heat exchanging pipe 73 to the throttle intake 75 of the intake manifold manifold downstream of the throttle valve.

It will be appreciated that the open end of the throttle intake for admitting fresh air is normally connected to an air filter (not shown, for clarity)

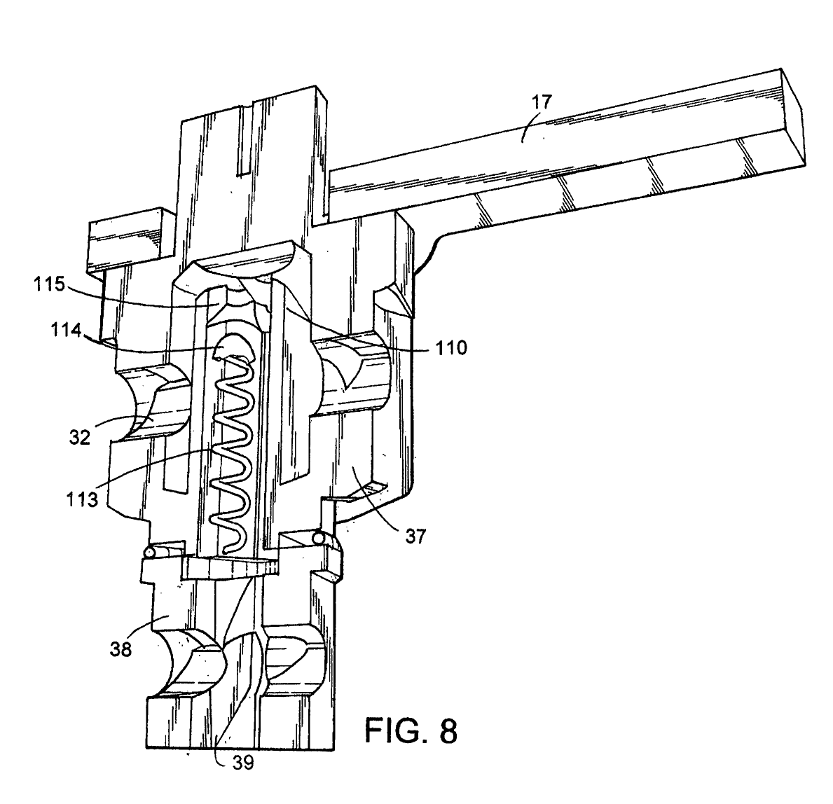

As shown in FIG. 8, the fuel flow control valve or regulator 17 comprises upper and lower bored cylindrical metal blocks 37, 38, respectively, joined by an annular seal. The upper block has a series of 4 ports 32 arranged cruciform fashion communicating with a cylindrical outer chamber 110 formed in the upper block interior for receiving fuel pumped from the gas tank 79 through line 35 via one port 32 and outputting fuel to the first and second preheaters 11 and 12 via two other ports extending transversely thereof and through fuel lines 29 and 59, respectively. The fourth port is closed. An inner vertical cylindrical valve body 111 houses a pressure relief valve formed by a spring 113 biasing a ball member 114 toward valve orifice 115 which opens when the fuel pressure in the outer chamber exceeds approximately three atmospheres to admit fuel into the valve body 111 and vent the fuel through a vertical bore 113 in the lower block exiting through port 39 and back to the tank through return fuel line 36/78. The return fuel line 30 from the low temperature preheater 11, connects to the return fuel line 36/78. The remaining ports in the lower block 38 are closed.

The air flow controller 16 comprises a solenoid operated valve having a valve body 81 with air input and air output fittings 82 and 83, respectively, connected to receive air from the air filter 85 and supply air via air line 61 to port 60 of the first low temperature stage 13 of the preheater 12. Control signal lines 86 connect the actuating solenoid 87 to the computer 20.

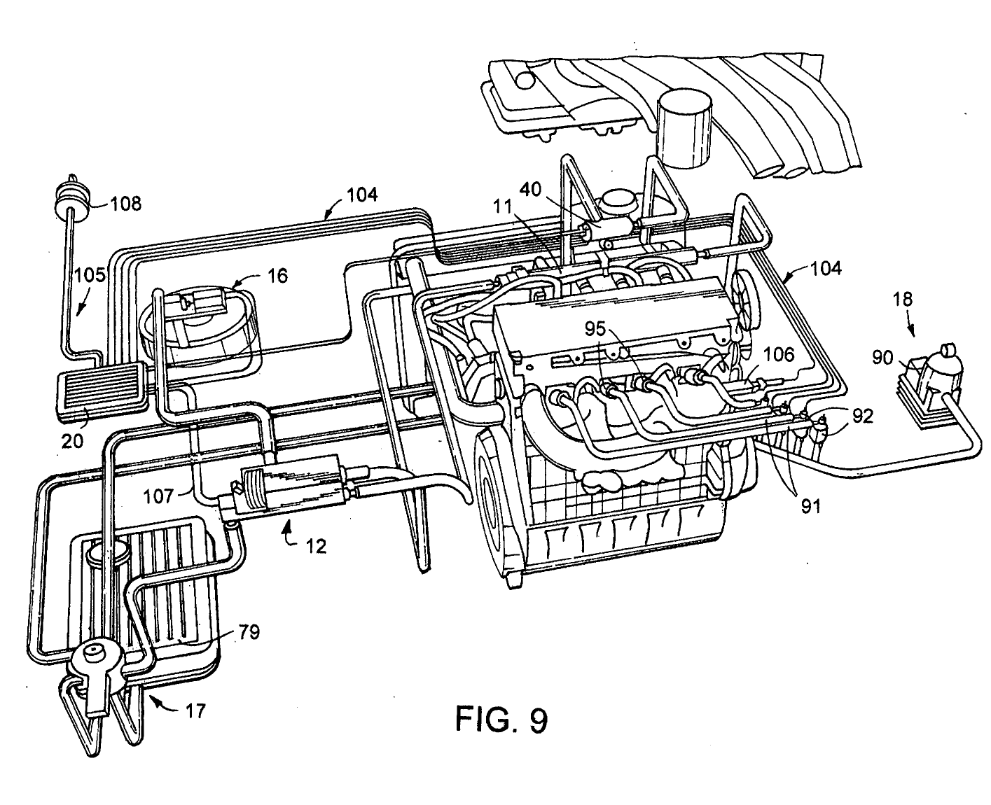

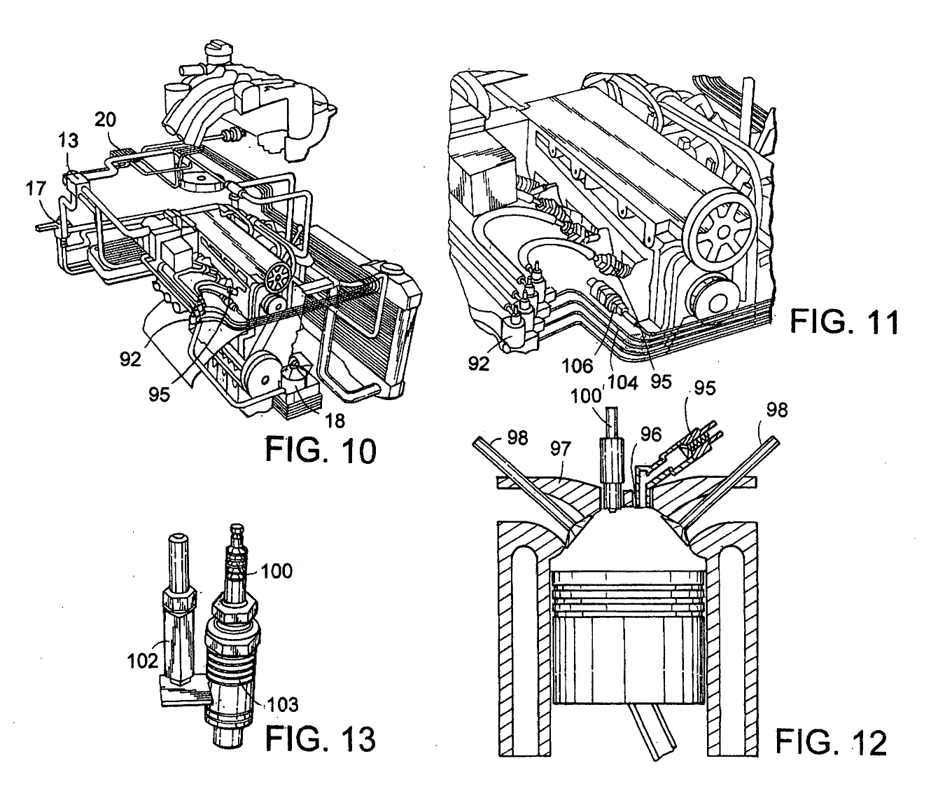

As shown in FIG. 9-13, the air compressor or electronic booster 18 comprised an electric pump powered by the vehicle battery which charges one or more tanks 90 with compressed air. The tank output is connected by respective airlines 91 and solenoid valves 92 to one way valves 95, spring biased closed, inserted in bores 96 in respective cylinder heads 97 between the intake and exhaust valves 98, 98′, on the intake valve side of the spark plug 100. The spring strength regulates the internal cylinder air pressure.

In an modification, shown in FIG. 13, the need for a separate bore in the cylinder head is obviated by a unit 101 which incorporates the air valve 102 with a spark plug holder 103.

Sequential operation of the solenoid valves is controlled by the computer 20 connected thereto by respective signal wires 104.

Further signal wires connect the computer 20 to the oxygen sensor 106 to receive readings therefrom, (wires 105) to the ignition 108, and (wires 107) to the injector of the preheater 13.

In a typical starting sequence, inserting the ignition key into the ignition 108 signals the computer to turn on a red warning lamp (LED) (not shown) and sends a signal via control signal wires to actuate cold start heater 40 for approximately 3-5 seconds to preheat a small quantity (e.g 20-25 gm) of fuel to a predetermined temperature and then turns off the warning lamp. The operator then turns the ignition key to start the engine. In response, the computer allocates approximately one minute for engine warm-up with a cross check of radiator fluid temperature and radiator fluid circulates through the lower temperature stage, 13, of the gasifier 12. When the fluid temperature reaches approximately 60 degrees centigrade, the temperature of the second, atomizing stage is approximately 200-300 degrees centigrade.

The computer regulates the lambda (air: fuel ratio) from oxygen sensor readings, and the throttle position and controls the supply of fuel fed to the preheater 11 and gasifier 12, accordingly. The computer 20 is operatively connected to the conventional vehicle computer which responds to a signal indicating an increase in sensed vacuum corresponding to depression of the throttle for power demand by increasing fuel injection from the fuel rail with the first low temperature preheater 11 while the computer also responds to the oxygen content sensed by the oxygen sensor by operating the solenoid valves to increase the supply of compressed air to the individual cylinders—corresponding to a power mode and to decrease the supply to zero in response to a lower vacuum pressure of a cruise condition—corresponding to an economode performance—in which fuel injected from the fuel rail is substantially zero and the only fuel supplied to the engine is that atomized by the gasifier 12 and delivered through the throttle intake. The heat supplied to the fuel rail is dependent on the operating temperature of the engine and the elevated temperature and pressure of the fuel therein is maintained by restricting the return flow of fuel to the gas tank by providing the constriction or venturi of approximately 0.1-0.3 mm diameter in the return fuel line. The permissible maximum temperature is dependent on the fuel type, being 70-90 degrees at approximately twice atmospheric pressure for gas and approximately 80-100 degrees C. for alcohol, such elevated pressure enabling the fuel to be superheated without vaporization.

The cracking process releases more oxygen, hydrogen and carbon from alternative (methanol based) fuel, enhancing complete combustion while the reduced temperature increases the oxygen density of fuel output from the gasifier to the cylinders.

Typical comparative performance figures for the exhaust emissions of system of the invention when using M85 and 100 gas by comparison with a regular gas powered engine without preheating or an air booster:

| | MFS (M85) | Regular Gas Engine | MFS (100 GAS) |
|---|---|---|---|
| CO | 0.01 ppm | 0.50 ppm | 0.01 ppm |
| HC | 20 | 650 | 20 |
| NOX | 175 | 3500 | 400 |
| CO₂ | 13 | 16 | 12.5 |
| Lambda | 1.15 | 1.00 | 1.29 |

The favorable environmental impact in terms of reductions of exhaust content of CO, HC and NOX is clearly considerable.

Conventionally, the consumption of M85 (85% Methanol, 15% benzene) required for a given power output has been much greater than gasoline as Methanol has a substantially lower calorific value than gasoline/petroleum. However, the gasifier/atomizer of the invention is sufficiently effective to increase the efficiency/completeness of combustion and therefore the power output of methanol to at least that of gas in a regular engine so that an equivalent power output to gas in a conventional engine can be obtained when using methanol without the addition of benzene to improve volatility. A corollary, is that, when using gas, the gas mileage can be increased from, for example, 24 m.p.g of a conventional engine to 36 m.p.g. as a result of the increased atomization and other features of the invention.

In a diesel and methanol type engine application, shown in FIG. 14, a tubular initial reactor chamber section 124 with injectors for methanol is interposed between the air filter intake 85′ and the intake of a turbocharger 125. A fuel distributor box 123 splits an additional supply of alternative fuel type methanol from an additional tank into three branches, (one to three, based on engine size), connected to individual injectors positioned at 120 degree intervals. The heat generated by the turbo—which reaches approximately 1000 degrees centigrade (without the reactor effect) is transmitted to the fuel-air stream drawn therethrough The reactor effect reduces the temperature of the turbo to approximately 200 degrees centigrade and the fuel-air mixture output to approximately 10-20 degrees centigrade or ambient temperature, (avoiding a need for a conventional intercooler), and improving engine efficiency as a result of the increase in the oxygen availability, enrichment or density arising both from the cracking and the drop in fuel temperature compared with conventional turbo operation. The lowered temperature will also extend the life of the turbo. Each injector is controlled by the computer to operate for 2-3 milliseconds. The provision of several individual injectors enables easier calibration for the engine for maximal cracking/gasifying. The size and number of injectors are calculated on the basis of the engine size.

In the diesel, a separate tank of alternative fuel is provided in addition to the main tank (not shown) of diesel fuel and only the alternative fuel is fed through the turbo via the injector(s).

Although the present system computer is not linked to the conventional computer in the vehicle, the conventional computer will increase or decrease the amount of fuel supplied to the conventional injectors in a complementary manner to the system computer to compensate for any deficit or excess of power arising from a decrease or increase in fuel fed to the reactor injector.

For example, when high engine power is required, insufficient power can be derived from the reactor system alone and the conventional computer detects and responds to the deficit by increasing the supply of fuel to the conventional injectors. In a low power mode, when the power derived from the reactor system is sufficient, the main computer reduces or shuts down the fuel supply to the conventional injectors.

Cold starting uses only diesel (without electrical preheating). When the system computer senses that the temperature of the engine has risen sufficiently, the computer starts the reactor injector.

It must be appreciated that, in later developed embodiments as described hereafter, the low temperature liquid fuel preheater 11 shown in FIGS. 2 and 3; the lower temperature heat exchanger 13 heated by radiator fluid; and the mesh lining 62 are all omitted.

In the air-charged gasoline system shown in FIG. 16, primed reference numerals are assigned to some elements similar to those previously described for ease of reference.

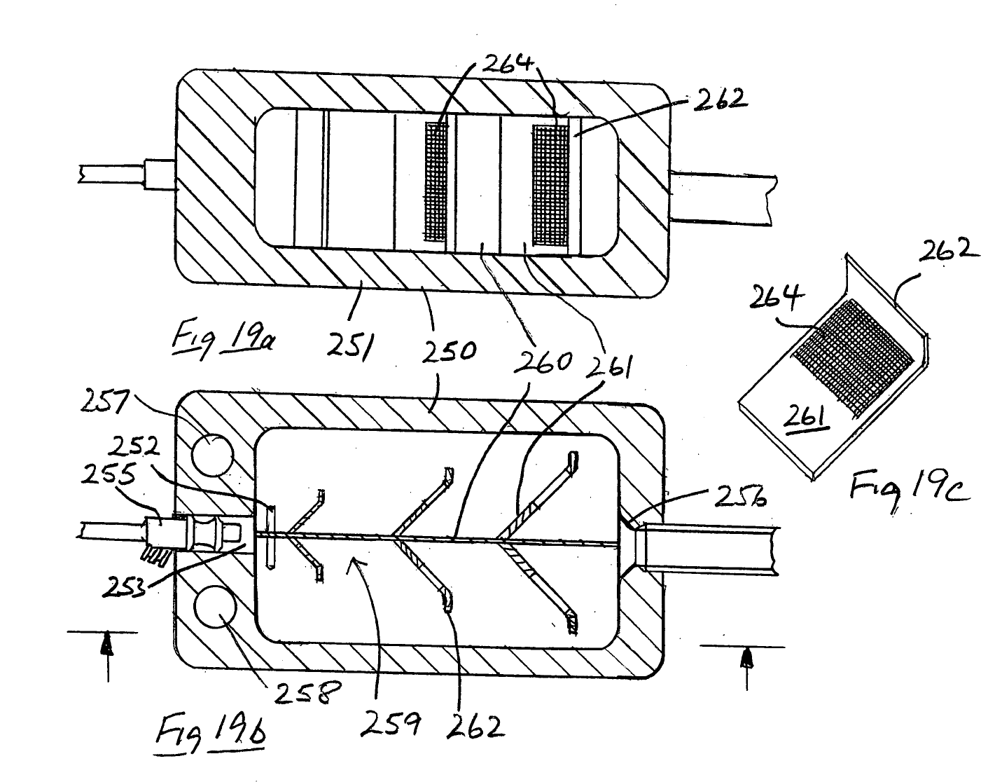

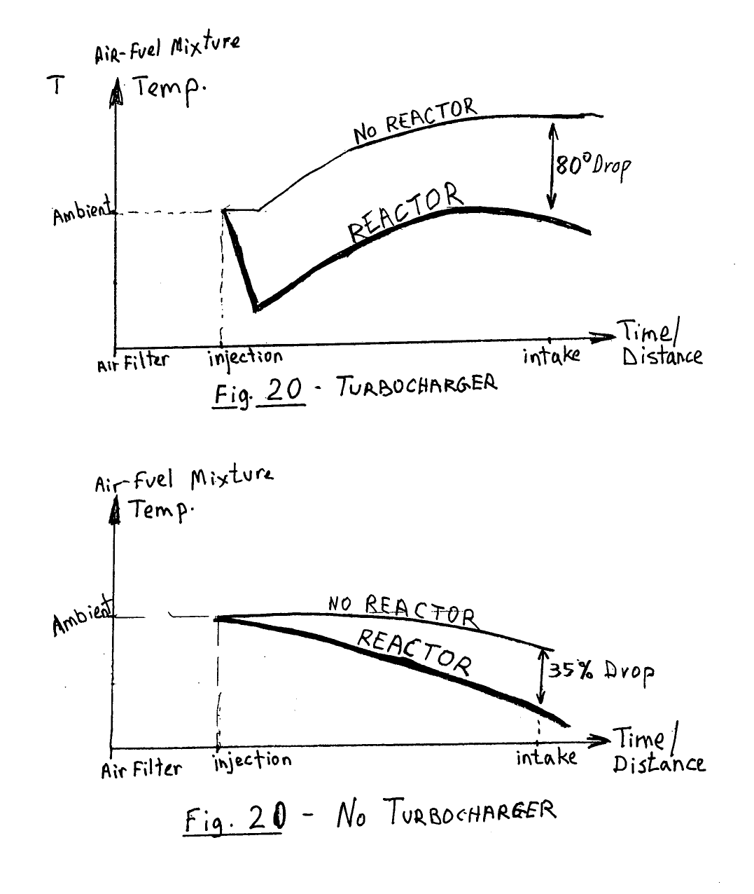

The cracking reactor 250 is shown in FIGS. 19a and 19b and does not have two stages but only a single stage suitable for both low and high temperatures, being heated by circulating engine coolant or engagement with the exhaust manifold, respectively, as in the present embodiment, being mounted (without coolant) on the exhaust manifold 69′ of conventional (4 cylinder) i.c. engine 2. Single fuel tank 79′ supplies a preselected alternative fuel (or conventional gasoline) to the main conventional injection pump 3 via main fuel line 4 and a diverted portion to injector 57′ of the reactor via branch line 5. Fresh air is supplied via line 6 to the intake manifold 8 when the gas pedal is depressed to open throttle valve 7, and a diverted portion via branch line 9 to air pump/turbine 19 and thence via control valve 26 to the reactor chamber.

The cracked fuel-air mixture output from the reactor chamber is fed via line 130 to the air intake manifold downstream of the throttle valve 7 for mixing with the intake of fresh air. The additional computer (control system) 20′ has control (signal) wires connected to the air pump 19, the turbo output valve 26 and the cracking injector 57′ and signal wires receives operating parameter signals from the electric speedometer 131, engine coolant output thermometer 132, fuel type sensor 133 and gas pedal position sensor 134 (or from the vacuum sensor in injectors via line 135 for vehicle motion, in the case of cruise control). The computer provides a wait state of approximately 2-4 seconds even when vehicle motion is detected before opening the valve 26 to start the turbo to obviate risk of excessive torque surge damaging the gear box.

The high pressure air injection into the reactor chamber increases the oxygen level, improving efficiency and raising the power. It also avoids a need for heat resistant components and four individual assemblies required for air injection into individual cylinders.

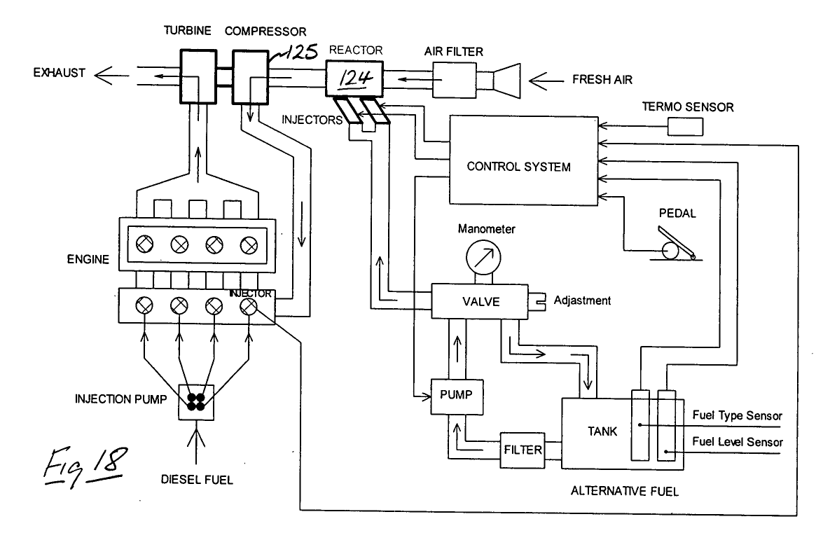

Although the turbogasoline embodiment uses only a single fuel type at any one time, e.g gasoline or M85, the diesel and turbodiesel systems shown in FIGS. 17 and 18 utilize, in addition to diesel, an alternative type of fuel source which is the only fuel cracked in the reactor. Only diesel powers the engine when idle and some diesel still powers the engine in the power mode.

In the diesel system of FIG. 17, a portion of fresh air is diverted, merely by induction pressure, from the air filter to the reactor which is provided with two reactor injectors adjusted to inject at high pressure (3-4 atmospheres). Diesel is always supplied to the conventional injection pump from a main tank (not shown) and a supply of alternative fuel is pumped by pump 144 to the reactor from an additional tank 145 of alternative fuel under direction of the system computer/control system 146. The computer 146 has input parameter signal lines connected to receive information from both a fuel type sensor and a fuel level sensor 147 and 148, respectively, the engine coolant thermometer; the gas pedal position 150 or throttle valve position 151; and injector vacuum sensor 152. Only diesel is fed during idle mode and both fuels are fed in power mode.

Although a power increase of as much as 95% has been recorded, the computer governs the power increase down to 35% for safe operation to avoid excessive engine component stresses.

In the turbodiesel system shown in FIG. 18 a downstream portion of a reactor reactor chamber is formed by the turbocharger body interior as described above in relation to FIG. 14. The same inputs to the control computer are sensed. The energy to sustain the cracking is taken from the heat of the turbocharger.

The embodiment of cracking reactor shown in FIGS. 19a and 19b, comprises only a single chamber 250 having an aluminium wall 251, air inlet aperture 252 and fuel inlet apertures 253 at one axial end seating an air inlet aperture pipe (not shown)and a fuel cracking injector 255. The opposite axial end is formed with an outlet aperture 256 for the cracked fuel-air mixture. Ducts 257, 258 are formed within the wall thickess for circulating hot engine coolant for heating the chamber. A heat exchanging device 259 is mounted inside the chamber and comprises an axial, central spinal strip 260 from respective opposite faces of which extend two rows of three equi-spaced heat exchanging reflector fins 261 of increasing size with respective free ends 262 turned out toward the chamber wall to produce mixing vortices. Successive fins are of greater thicknesses and lengths than preceidng fins. The second and third fins have mesh screens 264 of 60-80 micron pore size aligned axially respectively with the turned out ends of the first fins so that only the smaller atomised droplets with most cracked molecules or gasified fuel molecules will pass directly through the mesh and thence to the outlet but, the larger droplets with fewer uncracked molecules will be deflected by the mesh into vortices and heated further by the chamber walls and fins which increase the residence period of the fuel in the chamber for increased exposure to permit more exposure for increased cracking. The spinal strip and fins are made of heat conducting and reflecting material such as copper. The first, smallest fin is 2 mm thick copper sheet, the second, middle fin is 4 mm thick and the third final fin is 6 mm thick. The air inlet aperture is elongate and extends across a longitudinal edge portion of the spinal strip to distribute inlet air evenly on respective opposite sides of the spinal strip.

The outlet 256 is funnel shaped to permit a fuel-air mixture to exit through the outlet in a streamline flow.

Heat exchanging fins are mounted on the outlet pipe (not shown) to prevent the temperature of the cracking fuel-air mixture falling too low.

When alcohol is used as an alternative fuel and cracked in the chamber circulating hot engine coolant through the chamber is sufficient to sustain cracking but for gasolene and other fuels having a higher vaporization temperature the chamber is simply strapped against, or otherwise mounted in abutment with the exhaust manifold for heating to a significantly higher temperature.

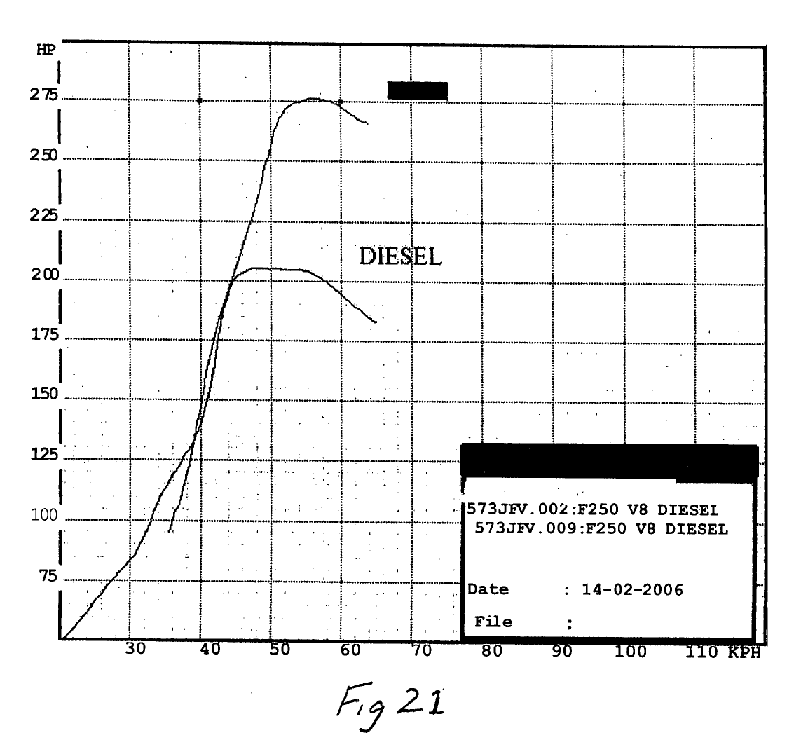

As shown schematically in FIGS. 20 and 21, the presence of the cracking reactor reduces the temperature of the fuel-air mixture entering the manifold relative to the air alone in the absence of the reactor when a conventional turbocharger is installed by approximately 80% (in numerical terms) and, without a turbocharger by approximately 35% (in numerical terms), respectively.

1. A method for improving the performance of an internal combustion engine having a conventional liquid fuel supply and fuel injection system comprising the steps of:
providing a reactor chamber having an inlet and an outlet connected to the engine intake manifold;
providing a fuel cracking injector additional to the main fuel injection system and an air supply at the inlet of the reactor chamber;
supplying, during engine operation, only a portion of the fuel required for engine operation to the additional fuel cracking injector as a liquid at ambient temperature;
operating the fuel cracking injector to inject the fuel portion into the inlet of the reactor chamber thereby initiating cracking of the injected fuel portion in the reactor chamber by pressure drop and forming a fuel-air mixture;
applying heat energy emitted by a conventional engine component operating normally at high temperature to the reactor chamber to sustain continued cracking of the fuel in the reactor chamber so that cracked fuel is output to the intake manifold as a continuous fuel-air stream at no higher than ambient temperature.

2. A method according to claim 1 wherein the internal combustion engine is a diesel engine and the liquid fuel portion is mainly an alcohol and is injected by the cracking injector at a pressure of 3-4 bar.

3. A method according to claim 1 wherein the engine component emitting the heat energy is one of the engine cooling system and the engine exhaust system according to whether the fuel portion has a lower and higher vaporization temperature, respectively.

4. A method according to claim 1 wherein a portion of the reactor chamber at the outlet end is formed by an internal air inlet duct of a turbocharger an external portion of which forms the component emitting the heat energy applied to the reactor chamber.

5. A method according to claim 4 wherein an inlet end of the reactor chamber comprises a tubular duct wall having one inlet end connected to receive air from an air filter and an opposite axial end connected to the inlet duct of the turbocharger and a plurality of said fuel cracking injectors are mounted around the duct wall to inject said portion of liquid fuel into the duct for flow through the turbocharger.

6. A method according to claim 3 wherein the temperature of the fuel-air mixture output from the reactor chamber to the intake manifold is a few degrees below zero degrees centigrade.

7. A method according to claim 4 wherein the temperature of the fuel-air mixture output from the reactor chamber to the intake manifold is 30% of the outlet temperature of a conventional engine without turbocharger and 80% of the outlet temperature of a conventional engine with turbocharger.

8. A method according to claim 1 wherein the air supply provides compressed air only on an engine high power demand.

9. A method according to claim 1 comprising the step of supplying compressed air into the cylinder head only on an engine high power demand.

10. A method according to claim 8 or claim 9 wherein the compressed air is provided from one of a storage tank and a pump.

11. A method for improving the performance of an internal combustion engine having a conventional liquid fuel supply and fuel injection system by feeding, during engine operation, only a portion of fuel needed for engine operation as a liquid at ambient temperature to an additional fuel cracking injector operating at high pressure to initiate cracking of the fuel by pressure drop and mixing the cracking fuel with air while applying waste heat energy from a conventional engine component operating normally at high temperature to sustain the cracking and feeding mostly cracked fuel-air mixture as a continuous stream at a temperature no greater than ambient to the engine intake manifold for combustion with a remainder of the fuel supplied to the engine during engine operation.

12. A method according to claim 11 wherein the operational pressure of the additional fuel cracking injector is 3-4 atmospheres.

13. A method according to claim 11 wherein the engine component from which waste heat is applied is one of the engine exhaust manifold and engine coolant according to one of a lower and higher alcohol content of the fuel portion, respectively, requiring one of a higher and lower temperature for vaporization, respectively.

14. A method according to claim 11 wherein the engine component from which waste heat is applied is an engine turbocharger.

15. A method according to claim 11 wherein, in a gasoline engine, said portion of fuel is diverted from a conventional engine fuel supply tank.

16. A method according to claim 11 wherein, in a diesel engine, there is an additional fuel supply tank and said portion of fuel supplied to the cracking injector operating at high pressure is fed from said additional fuel supply tank.

17. A system for improving the performance of an internal combustion engine having a main fuel supply and combustion system comprising:
a fuel cracking reactor comprising a chamber having an inlet and an outlet;
means for connecting an air source to the inlet;
a fuel cracking injector for the cracking chamber arranged to inject fuel at high pressure into the reactor chamber inlet;
means for connecting the outlet to an intake manifold of the internal combustion engine;
means for supplying the chamber with waste heat emitted by a pre-selected engine component during normal operation;
means for feeding to the cracking injector, during engine operation, a portion of engine fuel at ambient temperature required to sustain engine operation;
a computer control system connected to receive signals from:
a) engine temperature detecting means for detecting a temperature of engine coolant;
b) means for detecting a position of one of an engine gas pedal and throttle valve position;
c) means for sensing a type of fuel present in an engine fuel tank;
the computer control system being programmed to start operation of the cracking injector in response to a signal received from the engine temperature detecting means corresponding to a minimum temperature of the engine required to permit the cracking chamber to reach a temperature sufficient to sustain continuous cracking so that the injected fuel portion is mixed with air and undergoes continuous cracking in the chamber sustained by the heat energy supplied from the selected engine component and the cracked fuel is fed to the intake manifold as a continuous fuel-air stream stream at no greater than ambient temperature.

18. A system according to claim 17 wherein engine fuel is supplied from a single fuel tank and said means for feeding a portion of engine fuel to the cracking injector diverts such fuel portion from engine fuel supplied from the single fuel tank.

19. A system according to claim 17 wherein the fuel feeding means feeds the portion of fuel to the reactor cracking injector from an additional supply of alternative fuel in an additional alternative engine fuel tank and fuel level sensing means are mounted in the additional tank and connected to the computer for sensing an amount of fuel present in the alternative engine fuel tank for providing a fuel level status signal to the computer.

20. A system according to claim 17 wherein an electric speedometer and vacuum sensor of engine fuel cracking injectors are connected to the computer so that when one of a signal received by the computer from the gas pedal indicates that the gas pedal is depressed and a signal received from the speedometer indicates that the vehicle powered by the engine is stationary, the computer implements a time delay of approximately 2-4 seconds before starting the cracking injector.

21. A system according to claim 17 wherein the engine is a gasoline engine and the computer is connected to an oxygen sensor and programmed to detect the oxygen level.

22. A system according to claim 17 wherein the reactor chamber is elongate having the inlet and the outlet at respective opposite longitudinal ends so that only the most cracked gasified fuel mixture exits the chamber through the outlet.

23. A system according to claim 17 wherein the engine is a gasoline engine system and the reactor chamber comprises an elongate tube having a first stage at the inlet and a second stage at the outlet, the first stage having ducts connected to receive coolant heated by the engine and the second stage being heated by engine exhaust heat.

24. A system according to claim 17 wherein the reactor chamber has an internal wall surface lined internally with heat exchanging fins to facilitate heat transfer to the cracking fuel in the chamber.

25. A system according to claim 17 wherein the air source provides compressed air only on an engine high power demand.

26. A system according to claim 17 further comprising means for supplying compressed air into a cylinder head only on an engine high power demand.

27. A system according to claim 25 or 26 wherein the compressed air is supplied from one of a storage tank and an air pump.

28. A fuel cracking reactor comprising an elongate chamber of heat conducting material having an air inlet aperture and a fuel cracking injector at one longitudinal end and an outlet for cracked fuel-air mixture at an opposite longitudinal end, a heat exchanging device comprising a central axial spinal metal strip extending axially along the chamber away from the one end, the strip having opposite faces from which respective rows of heat exchanging reflector fins extend inclined away from the spinal strip and the one end in axially spaced apart, parallel relation, across the chamber towards respective opposite chamber side walls, the fins having respective free ends turned outward away from the spinal strip toward respective opposite chamber walls to produce mixing vortices; at least a second fin and a third fin in each row from the one end having a screen of fine mesh in axial alignment with each other and with a free end of a first fin so that only finely atomized and gasified fuel and air will tend to pass through the mesh and thence directly to the outlet but, larger droplets with fewer cracked molecules will be deflected by the mesh into vortices and heated further by the chamber walls and fins increasing the residence period in the chamber to permit more exposure for additional cracking, atomization and gasification.

29. A fuel cracking reactor according to claim 28 wherein screens of successive fins are of greater area than the screens of preceeding fins.

30. A fuel cracking reactor according to claim 28 wherein the mesh has a pore size of 60-80 micron.

31. A fuel cracking reactor according to claim 28 wherein successive fins are of greater lengths and thicknesses than preceding fins.

32. A fuel cracking reactor according to claim 28 wherein ducts are formed within the wall thickness for circulating hot engine coolant for heating the chamber

33. A fuel cracking reactor according to claim 28 wherein the air inlet aperture is elongate and extends across a longitudinal edge portion of the spinal strip to distribute inlet air evenly on respective opposite sides of the spinal strip.

34. A fuel cracking reactor according to claim 28 wherein the outlet is funnel shaped to permit a fuel-air mixture to exit through the outlet in a streamline flow.
